(19) United States
(12) Patent Application Publication
(10) Pub. No.: US 2012/0083953 A1
(43) Pub. Date: Apr. 5, 2012

(54) CONTROL DEVICE

(75) Inventors: Jin IZAWA, Obu (JP); Yasuhiko KOBAYASHI, Anjo (JP)

(73) Assignee: AISIN AW CO., LTD., Anjo-shi (JP)

(21) Appl. No.: 13/240,433

(22) Filed: Sep. 22, 2011

(30) Foreign Application Priority Data
Sep. 30, 2010 (JP) 2010-221883

(51) Int. Cl. B60W 10/08; B60W 20/00; B60W 10/11

(52) U.S. Cl. 701/22; 180/65.265

(57) ABSTRACT

A control device capable of executing damping control of outputting a damping torque command that suppresses vibration of a rotational speed of a rotating electrical machine caused at least by elastic vibration of a power transmission mechanism. This is accomplished by using feedback control based on the rotational speed of the rotating electrical machine. The control device executes the damping control by a direct-coupling damping controller when the engagement state of the engagement device is a direct-coupling engagement state in which there is no rotational speed difference between engagement members, and executes the damping control by a non-direct-coupling damping controller different from the direct-coupling damping controller in a case where the engagement state of the engagement device is a non-direct-coupling engagement state other than the direct-coupling engagement state.

### INCORPORATION BY REFERENCE

The disclosure of Japanese Patent Application No. 2010-221883 filed on Sep. 30, 2010 including the specification, drawings and abstract is incorporated herein by reference in its entirety.

### BACKGROUND OF THE INVENTION

The present invention relates to control devices for controlling a rotating electrical machine that is selectively drivingly coupled to an internal combustion engine in accordance with an engagement state of an engagement device, and that is drivingly coupled to a wheel via a power transmission mechanism.

### DESCRIPTION OF THE RELATED ART

Regarding such a control device, a technique of a vibration suppression control device as shown below is disclosed in, e.g., Japanese Patent Application Publication No. JP-A-2004-322947 below. This vibration suppression control device is applied to a drive system as in, e.g., a series/parallel type hybrid vehicle, in which a natural frequency and an attenuation factor of a power transmission system in the entire vehicle change in accordance with engagement or disengagement of an engagement device between an internal combustion engine and a rotating electrical machine, and output torque of the rotating electrical machine is continuously controlled and transferred to the side of the wheels. This vibration suppression control device performs control of suppressing vibration of the power transmission system by causing the rotating electrical machine to output damping torque. In this case, the vibration suppression control device is configured to set constants of a phase compensator (a phase compensation filter) in accordance with a control signal that is applied upon switching of the engagement state of the engagement device, and to continuously change each constant of the phase compensator so that an output of the phase compensator does not suddenly change in a discontinuous manner. This vibration suppression control device having such a configuration is intended to prevent vibration that is caused by a sudden change in drive torque command value for the rotating electrical machine upon switching of the engagement state of the engagement device, thereby reducing discomfort that the user feels due to torsional vibration of the power transmission system of the vehicle.

However, the inventor of the present application has found, through examination, that the natural frequency of the power transmission system of the vehicle discontinuously switches before and after the rotational speed difference between engagement members of the engagement device becomes zero, in accordance with the engagement state of the engagement device. Thus, the inventor has found that the configuration that continuously changes a command value of damping torque that is output from the rotating electrical machine as in the above vibration suppression control device cannot appropriately suppress the torsional vibration of the power transmission system of the vehicle immediately after the natural frequency of the power transmission system switches. Moreover, the above vibration suppression control device performs feedforward control of setting the constants of the phase compensator in accordance with the control signal of the engagement device and reflecting the constants on the torque command value for the rotating electrical machine. This results in poor robustness of vibration suppression control in the case where the vibration frequency of the power transmission system of the vehicle actually changes.

### SUMMARY OF THE INVENTION

The present invention was developed based on such knowledge of the inventor as described above, and it is an object of the present invention to provide a control device capable of appropriately suppressing torsional vibration of a power transmission system in accordance with an engagement state of an engagement device that selectively drivingly couples an internal combustion engine to a rotating electrical machine.

A first aspect of the present invention provides a control device for controlling a rotating electrical machine that is selectively drivingly coupled to an internal combustion engine in accordance with an engagement state of an engagement device, and that is drivingly coupled to a wheel via a power transmission mechanism. In the control device, the control device is capable of executing damping control of outputting a damping torque command that suppresses vibration of a rotational speed of the rotating electrical machine caused at least by elastic vibration of the power transmission mechanism, by using feedback control based on the rotational speed of the rotating electrical machine, and the control device executes the damping control by a direct-coupling damping controller in a case where the engagement state of the engagement device is a direct-coupling engagement state in which there is no rotational speed difference between engagement members, and executes the damping control by a non-direct-coupling damping controller different from the direct-coupling damping controller in a case where the engagement state of the engagement device is a non-direct-coupling engagement state other than the direct-coupling engagement state.

Note that as used herein, the term “rotating electrical machine” is used as a concept including a motor (an electric motor), a generator (an electric motor), and a motor generator that functions both as a motor and a generator as necessary. As used herein, the term “drivingly coupled” refers to the state in which two rotary elements are coupled together so as to be able to transmit a driving force therebetween. This term is used as a concept including the state in which the two rotary elements are coupled together so as to rotate together, or the state in which the two rotary elements are coupled together so as to be able to transmit a driving force therebetween via one or more transmission members. Such transmission members include various members that transmit rotation at the same speed or at a shifted speed, and include, e.g., shafts, gear mechanisms, engagement elements, belts, and chains. Such transmission members may include engagement elements that selectively transmit the rotation and the driving force, such as a friction clutch and a dog clutch.

According to this first aspect, the damping controller that executes the damping control is switched between the direct-coupling damping controller and the non-direct-coupling damping controller in accordance with whether the engagement state is the direct-coupling engagement state in which there is no rotational speed difference between the engagement members of the engagement device, or the non-direct-coupling engagement state other than the direct-coupling engagement state. This enables a damping torque command value of the rotating electrical machine to be discontinuously switched in accordance with discontinuous switching of a natural frequency of a power transmission system of the vehicle before and after the rotational speed difference between the engagement members reduces to zero, and enables the damping control to be executed by using the appropriate damping controller separately before and after the rotational speed difference between the engagement members decreases to zero. Thus, vibration of the power transmission system can be appropriately suppressed. Moreover, according to this first aspect, the damping torque command of the rotating electrical machine is output by the feedback control based on the rotational speed of the rotating electrical machine. This allows the rotating electrical machine to output damping torque corresponding to actual vibration of the rotational speed of the rotating electrical machine. This makes it easier to ensure robustness of the damping control even in the case where the vibration frequency of the power transmission system of a vehicle actually changes.

According to a second aspect of the present invention, the direct-coupling damping controller may be set in accordance with a natural frequency of a power transmission system from the internal combustion engine to the wheel, and that the non-direct-coupling damping controller may be set in accordance with the natural frequency of the power transmission system from the rotating electrical machine to the wheel.

According to this second aspect, each of the direct-coupling damping controller and the non-direct-coupling damping controller is appropriately set in accordance with the natural frequency of the power transmission system in the engagement state of the corresponding engagement device. Thus, the appropriate damping controller can be used separately before and after the rotational speed difference between the engagement members decreases to zero, and vibration of the power transmission system can be appropriately suppressed at the time the rotational speed difference between the engagement members decreases to zero, and before and after the rotational speed difference between the engagement members decreases to zero.

According to a third aspect of the present invention, in the damping control, the control device may output the damping torque command by the feedback control that performs at least differentiation and filtering based on the rotational speed of the rotating electrical machine, and a control constant of the differentiation and the filtering in the direct-coupling damping controller and a control constant of the differentiation and the filtering in the non-direct-coupling damping controller may be set to be different from each other.

According to this third aspect, the feedback control can be appropriately performed in which the damping torque command of the rotating electrical machine is output based on the rotational speed of the rotating electrical machine. In this case, the direct-coupling damping controller and the non-direct-coupling damping controller in accordance with the engagement state of the engagement device can be appropriately set by merely appropriately setting the control constant of the differentiation and the low-pass filtering. Moreover, switching of the damping controller in accordance with the engagement state of the engagement device can be easily performed by a simple process of merely switching the control constant.

According to a fourth aspect of the present invention, the power transmission mechanism may include a speed change mechanism whose speed ratio can be changed, and the respective control constants of the direct-coupling damping controller and the non-direct-coupling damping controller may be changed in accordance with the speed ratio of the speed change mechanism.

According to this fourth aspect, the optimal direct-coupling damping controller and the optimal non-direct-coupling damping controller in accordance with the speed ratio of the speed change mechanism can be set even if the power transmission mechanism includes the speed change mechanism and the natural frequency of the power transmission system changes in accordance with the speed ratio of the speed change mechanism. Thus, vibration of the power transmission system can be appropriately suppressed even if the power transmission mechanism includes the speed change mechanism.

According to a fifth aspect of the present invention, the power transmission mechanism may include a speed change mechanism whose speed ratio can be changed, and execution of the damping control may be prohibited during a shifting operation of the speed ratio by the speed change mechanism.

During the operation of changing the speed ratio by the speed change mechanism, a friction engagement device in the speed change mechanism is usually in a slipping state, whereby transmission of vibration on the side of the rotational electrical machine to the wheel is significantly suppressed. Therefore, it is often not necessary to perform the damping control during the operation of changing the speed ratio.

According to this fifth aspect, unnecessary execution of the damping control is prohibited, whereby output torque of the rotating electrical machine can be reduced, and energy efficiency can be enhanced.

### BRIEF DESCRIPTION OF THE DRAWINGS

FIG. 1 is a schematic diagram showing a general configuration of a vehicle drive device and a control device according to an embodiment of the present invention;

FIG. 2 is a block diagram showing the configuration of the control device according to the embodiment of the present invention;

FIGS. 3A to 3C show schematic diagrams each showing a model of a power transmission system according to the embodiment of the present invention, where FIG. 3A shows a base model, FIG. 3B shows a non-direct coupling model, and FIG. 3C shows a direct-coupling model;

FIG. 4 is a block line diagram showing the power transmission system and the control device according to the embodiment of the present invention;

FIG. 5 is a block line diagram showing the power transmission system and the control device according to the embodiment of the present invention;

FIG. 6 is a Bode plot illustrating processing of the control device according to the embodiment of the present invention;

FIGS. 7A and 7B show Bode plots illustrating processing of the control device according to the embodiment of the present invention, where FIG. 7A shows an example of a non-direct coupling state, and FIG. 7B shows an example of a direct coupling state;

FIG. 8 is a Bode plot illustrating processing of the control device according to the embodiment of the present invention;

FIG. 9 is a timing chart illustrating processing in the case where no damping control is performed in the control device according to the embodiment of the present invention; and

FIG. 10 is a timing chart illustrating processing in the ease where the damping control is performed in the control device according to the embodiment of the present invention.

### DETAILED DESCRIPTION OF THE EMBODIMENT

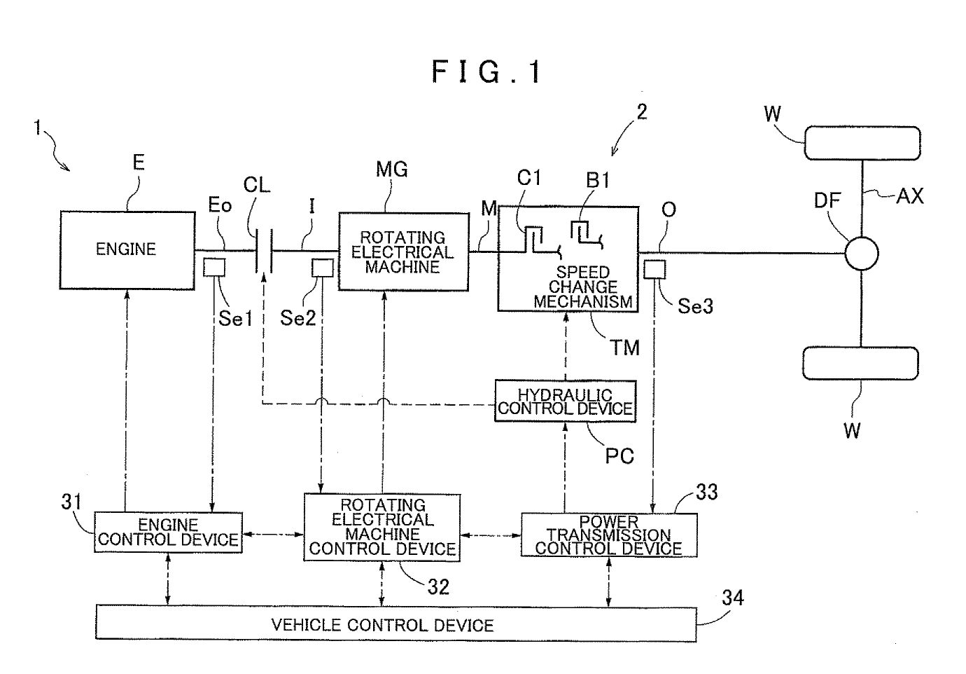

An embodiment of a rotating electrical machine control device 32 according to the present invention will be described below with reference to the accompanying drawings. FIG. 1 is a schematic diagram showing a general configuration of a vehicle drive device 1 according to the present embodiment. As shown in the drawing, a vehicle having the vehicle drive device 1 mounted thereon is a hybrid vehicle including as driving force sources an engine E as an internal combustion engine and a rotating electrical machine MG. In this drawing, solid lines represent a transmission path of a driving force, broken lines represent a supply path of hydraulic oil, and chain lines represent a transmission path of a signal. As shown in the drawing, the rotating electrical machine MG of the present embodiment is selectively drivingly coupled to the engine E according to an engagement state of an engine disconnect clutch CL, and is drivingly coupled to wheels W via a power transmission mechanism 2. The hybrid vehicle includes an engine control device 31 that controls the engine E, a rotating electrical machine control device 32 that controls the rotating electrical machine MG, a power transmission control device 33 that controls a speed change mechanism TM and the engine disconnect clutch CL, and a vehicle control device 34 that integrates these control devices to control the vehicle drive device 1.

In the present embodiment, the power transmission mechanism 2 has the speed change mechanism TM that is drivingly coupled to the rotating electrical machine MG and that is capable of changing a speed ratio Kr, and an output shaft O and axles AX that drivingly couple the speed change mechanism TM to the wheels W. The driving force of the driving force sources is shifted by the speed ratio Kr of the speed change mechanism TM, and is transmitted to the side of the wheels. Note that the engine disconnect clutch CL is the “engagement device” in the present application, and the rotating electrical machine control device 32 is the “control device” in the present invention.

In such a configuration, the rotating electrical machine control device 32 according to the present embodiment is capable of executing damping control of outputting a damping torque command value Tp that suppresses vibration of a rotational speed tom of the rotating electrical machine MG at least due to elastic vibration of the power transmission mechanism 2, by using feedback control based on the rotational speed tom of the rotating electrical machine MG. The rotating electrical machine control device 32 is characterized by executing the damping control by a direct-coupling damping controller 41 in the case where the engagement state of the engine disconnect clutch CL is a direct-coupling engagement state in which there is no rotational speed difference W1 between engagement members, and by executing the damping control by a non-direct-coupling damping controller 42 different from the direct-coupling damping controller 41 in the case where the engagement state of the engine disconnect clutch CL is a non-direct-coupling engagement state other than the direct-coupling engagement state, The rotating electrical machine control device 32 according to the present embodiment will be described in detail below.

### 1. Configuration of Vehicle Drive Device

First, the configuration of a power transmission system of the hybrid vehicle according to the present embodiment will be described. As shown in FIG. 1, the hybrid vehicle is a parallel-type hybrid vehicle, which includes the engine E and the rotating electrical machine MG as the driving force sources of the vehicle, and in which the engine E and the rotating electrical machine MG are drivingly coupled in series. The hybrid vehicle includes the speed change mechanism TM. By using the speed change mechanism TM, the hybrid vehicle shifts the rotational speed of the engine E and the rotating electrical machine MG transmitted to an intermediate shaft M, and converts the torque thereof to transfer the converted torque to the output shaft O.

The engine E is an internal combustion engine that is driven by fuel combustion. For example, various known engines such as a gasoline engine and a diesel engine can be used as the engine E. In this example, an engine output shaft Eo such as a crankshaft of the engine E is selectively drivingly coupled via the engine disconnect clutch CL to an input shaft I drivingly coupled to the rotating electrical machine MG That is, the engine E is selectively drivingly coupled to the rotating electrical machine MG via the engine disconnect clutch CL as a friction engagement element. Note that the engine output shaft Eo may be drivingly coupled to the engagement member of the engine disconnect clutch CL via other member such as a damper.

The rotating electrical machine MG has a stator fixed to a non-rotary member, and a rotor rotatably supported radially inside the stator. The rotor of the rotating electrical machine MG is drivingly coupled to the intermediate shaft M so as to rotate together therewith. That is, the present embodiment is configured so that both the engine E and the rotating electrical machine MG are drivingly coupled to the intermediate shaft M. The rotating electrical machine MG is electrically connected to a battery (not shown) as an electricity storage device. The rotating electrical machine MG is capable of functioning as a motor (an electric motor) that is supplied with electric power to generate motive power, and as a generator (an electric generator) that is supplied with motive power to generate electric power. That is, the rotating electrical machine MG is supplied with the electric power from the battery to perform power running, or stores in the battery the electric power generated by the rotation driving force transmitted from the engine E and the wheels W. Note that the battery is an example of the electricity storage device, and other electricity storage device such as a capacitor may be used, or a plurality of types of electricity storage devices may be used in combination. Note that hereinafter electric power generation by the rotating electrical machine MG is referred to as “regeneration,” and negative torque that is output from the rotating electrical machine MG during the electric power generation is referred to as “regenerative torque.” In the case where target output torque of the rotating electrical machine is negative torque, the rotating electrical machine MG generates electric power by the rotation driving force transmitted from the engine E and the wheels W, while outputting regenerative torque.

The speed change mechanism TM is drivingly coupled to the intermediate shaft M to which the driving force sources are drivingly coupled. In the present embodiment, the speed change mechanism is a stepped automatic transmission device having a plurality of shift speeds having different speed ratios Kr from each other. The speed change mechanism TM includes a gear mechanism such as a planetary gear mechanism, and a plurality of friction engagement elements B1, C1, . . . , in order to establish the plurality of shift speeds. The speed change mechanism TM changes the rotational speed of the intermediate shaft M at the speed ratio Kr of each shift speed and converts torque thereof to transfer the converted torque to the output shaft O. The torque thus transferred from the speed change mechanism TM to the output shaft O is distributed and transferred to the two axles AX, namely the right and left axles AX, via an output differential gear unit DF, and is transferred to the wheels W drivingly coupled to the axles AX. As used herein, the speed ratio Kr refers to a ratio of the rotational speed of the intermediate shaft M to the rotational shaft of the output shaft O in the case where each shift speed is established in the speed change mechanism TM. In the present application, the speed ratio Kr is the rotational speed of the intermediate shaft M divided by the rotational speed of the output shaft O. That is, the rotational speed of the intermediate shaft M divided by the speed ratio Kr is the rotational speed of the output shaft O. The torque that is transferred from the intermediate shaft M to the speed change mechanism TM, multiplied by the speed ratio Kr, is the torque that is transferred from the speed change mechanism TM to the output shaft O.

In this example, the engine disconnect clutch CL and the plurality of friction engagement elements B1, C1, . . . are engagement elements such as clutches and brakes, each having a friction material. These friction engagement elements CL, B1, C1 . . . are capable of controlling an oil pressure that is supplied, and thus controlling their engagement pressures, thereby continuously controlling an increase and decrease in transfer torque capacity. For example, wet multi-plate clutches and wet multi-plate brakes may be used as such friction engagement elements.

The friction engagement element transfers torque between its engagement members by friction between the engagement members. If there is a rotational speed difference (slipping) between the engagement members of the friction engagement element, torque (slip torque) having the magnitude of the transfer torque capacity is transferred from the member having a higher rotational speed to the member having a lower rotational speed by kinetic friction. If there is no rotational speed difference (slipping) between the engagement members of the friction engagement element, the friction engagement element transfers torque acting between the engagement members of the friction engagement element by static friction, with the upper limit of the torque being the magnitude of the transfer torque capacity. As used herein, the term “transfer torque capacity” refers to the magnitude of the maximum torque that can be transferred by the friction engagement element by friction. The magnitude of the transfer torque capacity changes in proportion to the engagement pressure of the friction engagement element. The “engagement pressure” refers to the pressure that presses the input-side engagement member (a friction plate) and the output-side engagement member (a friction plate) against each other. In the present embodiment, the engagement pressure changes in proportion to the magnitude of the oil pressure that is being supplied. That is, in the present embodiment, the magnitude of the transfer torque capacity changes in proportion to the magnitude of the oil pressure that is being supplied to the friction engagement element.

Each friction engagement element includes a return spring, and is biased to the disengagement side by a reaction force of the spring. If the force that is generated by the oil pressure supplied to each friction engagement element exceeds the reaction force of the spring, the transfer torque capacity starts being generated in each friction engagement element, and each friction engagement element changes from a disengaged state to an engaged state. The oil pressure at which the transfer torque capacity starts being generated is called a “stroke end pressure.” Each friction engagement element is configured so that the transfer torque capacity increases in proportion to an increase in oil pressure after the supplied oil pressure exceeds the stroke end pressure.

In the present embodiment, the “engaged state” refers to the state in which the transfer torque capacity is generated in the friction engagement element, and the “disengaged state” refers to the state in which no transfer torque capacity is generated in the friction engagement element. The “slipping engagement state” refers to the engagement state in which there is slipping between the engagement members of the friction engagement element, and the “direct-coupling engagement state” refers to the engagement state in which there is no slipping between the engagement members of the friction engagement element. The “non-direct-coupling engagement state” refers to the engagement state other than the direct-coupling engagement state, and includes the disengaged state and the slipping engagement state.

### 2. Configuration of Hydraulic Control System

A hydraulic control system of the vehicle drive device 1 will be described below. The hydraulic control system includes a hydraulic control device PC for adjusting an oil pressure of hydraulic oil that is supplied from a hydraulic pump to a predetermined pressure. Although detailed description thereof will be omitted, the hydraulic control device PC adjusts the operation amount of one or more regulating valves based on a signal pressure from a linear solenoid valve for adjusting the oil pressure, thereby adjusting the amount of hydraulic oil that is drained from the regulating valve, and adjusting the oil pressure of the hydraulic oil to one or more predetermined pressures. The hydraulic oil thus adjusted to the predetermined pressure is supplied to each friction engagement element of the speed change mechanism TM and the engine disconnect clutch CL, etc. at a respective required oil pressure level.

### 3. Configurations of Control Devices

The configurations of the control devices 31 to 34 that control the vehicle drive device 1 will be described below.

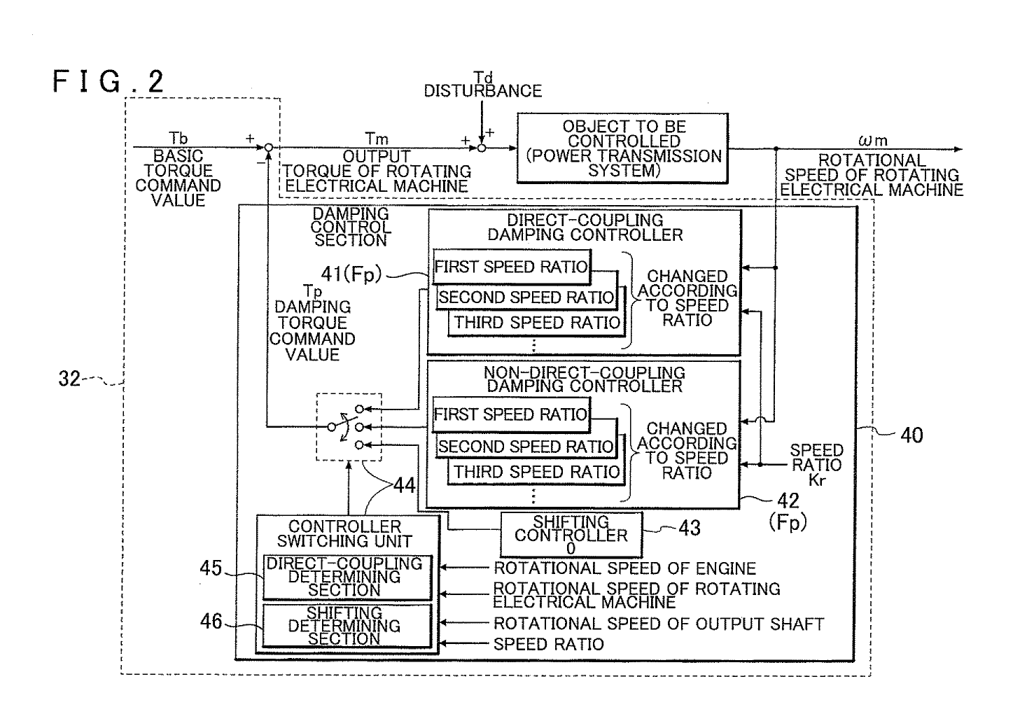

Each of the control devices 31 to 34 is configured to include as a core member an arithmetic processing unit such as a CPU, and to have a storage device such as a random access memory (RAM) capable of reading and writing data from and to the arithmetic processing unit, and a read only memory (ROM) capable of reading data from the arithmetic processing unit, etc. Each of function units 41 to 46 of the control devices 31 to 34 shown in FIG. 2 is formed by one or both of software (programs) stored in the ROM, etc. of the control device, and hardware such as an arithmetic circuit provided separately. The control devices 31 to 34 are configured to communicate with each other, and share various kinds of information such as detection information of sensors and control parameters, and perform cooperative control, whereby functions of the function units 41 to 46 are implemented.

The vehicle drive device 1 includes sensors Se1 to Se3, and electric signals that are output from each sensor are input to the control devices 31 to 34. The control devices 31 to 34 calculate detection information of each sensor based on the input electric signals. The engine rotational speed sensor Se1 is a sensor for detecting the rotational speed of the engine output shaft Eo (the engine E). The engine control device 31 detects the rotational speed (the angular velocity) ωe of the engine E based on the input signal of the engine rotational speed sensor Se1. The input shaft rotational speed sensor Se2 is a sensor for detecting the rotational speeds of the input shaft I and the intermediate shaft M. Since the rotor of the rotating electrical machine MG is integrally drivingly coupled to the input shaft I and the intermediate shaft M, the rotating electrical machine control device 32 detects the rotational speed (the angular velocity) ωm of the rotating electrical machine MG, and the rotational speeds of the input shaft I and the intermediate shaft M, based on the input signal of the input shaft rotational speed sensor Se2. The output shaft rotational speed sensor Se3 is a sensor that is attached to the output shaft O near the speed change mechanism TM, and detects the rotational speeds of the output shaft O near the speed change mechanism TM. The power transmission control device 33 detects the rotational speed ωo of the output shaft O near the speed change mechanism TM, based on the input signal of the output shaft rotational speed sensor Se3. Since the rotational speed of the output shaft O is proportional to the vehicle speed, the power transmission control device 33 calculates the vehicle speed based on the input signal of the output shaft rotational speed sensor Se3.

### 3-1. Vehicle Control Device

The vehicle control device 34 has a function unit that performs control of integrating, in the entire vehicle, various kinds of torque control that are performed on the engine E, the rotating electrical machine MG, the speed change mechanism TM, the engine disconnect clutch CL, etc., and engagement control of each friction engagement element, etc.

The vehicle control device 34 is a function unit that calculates output-shaft target torque as a target driving force to be transmitted from the side of the intermediate shaft M to the side of the output shaft O, in accordance with the accelerator operation amount, the vehicle speed, the amount of charge in the battery, etc., that determines the operation mode of the engine E and the rotating electrical machine MG, and that calculates target output torque of the engine E, target output torque of the rotating electrical machine, and target transfer torque capacity of the engine disconnect clutch CL, and that sends these target values to the other control devices 31 to 33 to perform integrity control.

The vehicle control device 34 determines the operation mode of each driving force source based on the accelerator operation amount, the vehicle speed, the amount of charge in the battery, etc. The amount of charge in the battery is detected by a battery state detection sensor. In the present embodiment, the operation modes include an electric mode in which only the rotating electrical machine MG is used as the driving force source, a parallel mode in which at least the engine E is used as the driving force source, an engine power generation mode in which regeneration of the rotating electrical machine MG is performed by using the rotation driving force of the engine E, a regeneration mode in which regeneration of the rotating electrical machine MG is performed by the rotation driving force that is transmitted from the wheels, and an engine start mode in which the engine E is started by the rotation driving force of the rotating electrical machine MG.

The operation mode in which the engine disconnect clutch CL is brought into the direct-coupling engagement state is the parallel mode, the engine power generation mode, and the engine start mode. As also shown in an example described below, in the engine start mode, the engine disconnect clutch CL is brought into the slipping engagement state during rotation of the rotating electrical machine MG, and positive torque having the magnitude of the transfer torque capacity is transferred from the engine disconnect clutch CL to the side of the engine E. As a reaction force to the positive torque, negative torque (slip torque) Tf having the magnitude of the transfer torque capacity is transferred from the engine disconnect clutch CL to the side of the rotating electrical machine MG

### 3-2. Engine Control Device

The engine control device 31 includes a function unit that performs operation control of the engine E. In the present embodiment, in the case where the engine control device 31 has received the target output torque of the engine E from the vehicle control device 34, the engine control device 31 sets the target output torque received from the vehicle control device 34 as a torque command value, and performs torque control so that the engine E outputs output torque Te having the torque command value. Note that in the case where combustion of the engine E is stopped, the output torque Te of the engine E is friction torque as negative torque.

### 3-3. Power Transmission Control Device

The power transmission control device 33 includes a function unit that controls the speed change mechanism TM and the engine disconnect clutch CL. Detection information of the sensors such as the output shaft rotational speed sensor Se3 is applied to the power transmission control device 33.

The power transmission control device 33 determines a target shift speed of the speed change mechanism TM based on the sensor detection information such as the vehicle speed, the accelerator operation amount, and the shift position. The power transmission control device 33 controls, via the hydraulic control device PC, the oil pressure that is supplied to each friction engagement element C1, B1, . . . in the speed change mechanism TM, thereby engaging or disengaging each friction engagement element and establishing the target shift speed in the speed change mechanism TM. Specifically, the power transmission control device 33 sends a target oil pressure (a command pressure) of each friction engagement element B1, C1, . . . to the hydraulic control device PC, and the hydraulic control device PC supplies an oil pressure having the value of the target oil pressure (the command pressure) to each friction engagement element.

The power transmission control device 33 temporarily controls the friction engagement element that is engaged or disengaged, to be in the slipping engagement state during normal switching (shifting) of the shift speed. During this shifting, the intermediate shaft M and the output shaft O are in a non-direct coupled state, and no torsional torque due to elastic (torsional) vibration is transferred between these members and torque caused by kinetic friction is transferred therebetween, or no torque is transferred therebetween.

The power transmission control device 33 controls the transfer torque capacity of the engine disconnect clutch CL. The power transmission control device 33 controls, via the hydraulic control device PC, the oil pressure that is supplied to the engine disconnect clutch CL, based on the target transfer torque capacity received from the vehicle control device 34, thereby engaging or disengaging the engine disconnect clutch CL.

### 3-4. Rotating Electrical Machine Control Device

The rotating electrical machine control device 32 includes a function unit that controls operation of the rotating electrical machine MG. In the present embodiment, in the case where the rotating electrical machine control device 32 has received the target output torque of the rotating electrical machine MG from the vehicle control device 34, the rotating electrical machine control device 32 sets the rotating electrical machine target output torque to a basic torque command value Tb. The rotating electrical machine control device 32 sets to a torque command value a value obtained by subtracting a damping torque command value Tp, described later, from the basic torque command value Tb, and performs torque control so that the rotating electrical machine MG outputs the output torque Tm having the torque command value. In the present embodiment, the rotating electrical machine control device 32 includes a damping control section 40 that calculates the damping torque command value Tp.

### 3-4-1. Damping Control Section

The damping control section 40 is a function unit that executes damping control of outputting the damping torque command value Tp, which suppresses vibration of the rotational speed ωm of the rotating electrical machine MG due to at least the elastic (torsional) vibration of the power transmission mechanism 2, by using feedback control based on the rotational speed ωm of the rotating electrical machine MG. The damping control section 40 executes the damping control by the direct-coupling damping controller 41 in the case where the engagement state of the engine disconnect clutch CL is the direct-coupling engagement state in which there is no rotational speed difference W1 between the engagement members. The damping control section 40 executes the damping control by the non-direct-coupling damping controller 42 different from the direct-coupling damping controller 41, in the case where the engagement state of the engine disconnect clutch CL is the non-direct-coupling engagement state other than the direct-coupling engagement state.

The damping control section 40 changes respective control constants of the direct-coupling damping controller 41 and the non-direct-coupling controller 42 in accordance with the speed ratio of the speed change mechanism TM. The damping control section 40 prohibits execution of the damping control during shifting of the speed ratio by the speed change mechanism TM.

Processing of the damping control that is executed by the damping control section 40 will be described in detail below.

### 3-4-2. Modeling to Shaft Torsional Vibration System

First, control design in the damping control will be described.

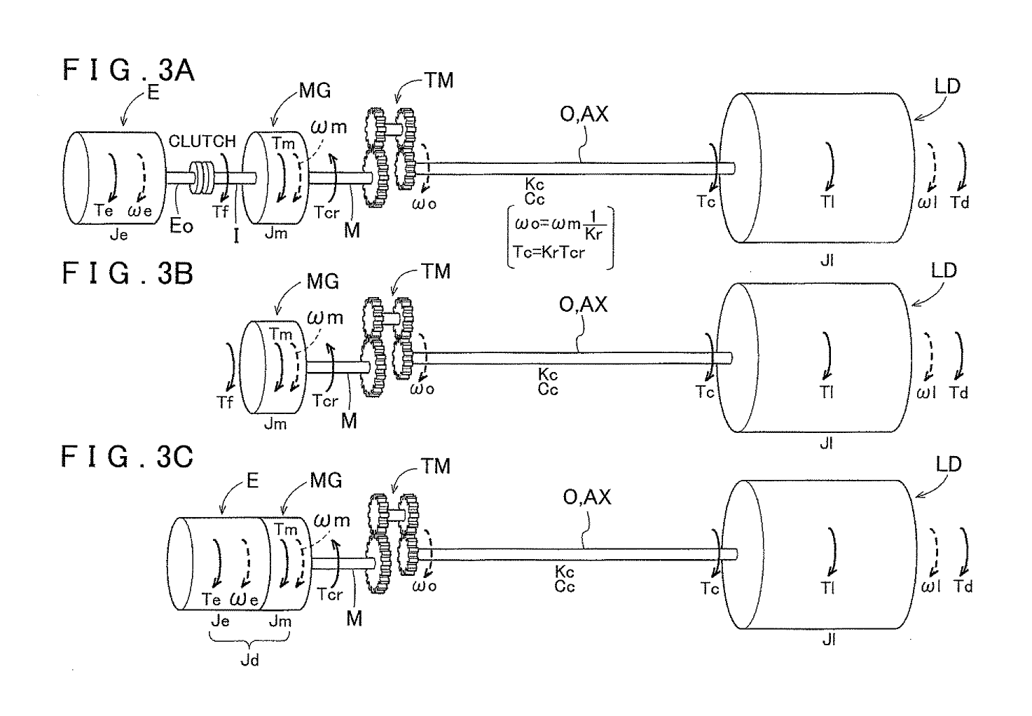

A base model of the power transmission system is shown in FIG. 3A. In this example, the power transmission system is modeled to a shaft torsional vibration system. Output torque Tm of the rotating electrical machine MG serves as control input to the shaft torsional vibration system, and the rotational speed ωm of the rotating electrical machine MG can be observed. The rotating electrical machine MG is selectively drivingly coupled to the engine E in accordance with the engagement state of the engine disconnect clutch CL, and is drivingly coupled to the vehicle as load LD via the speed change mechanism TM, and the output shaft O and the axle AX. The speed change mechanism TM shifts the rotational speed between the intermediate shaft M and the output shaft O at the speed ratio Kr, and performs torque conversion. Note that hereinafter, the output shaft O and the axle AX are collectively referred to as the “output shaft.”

The engine E, the rotating electrical machine MG, and the load LG (the vehicle) are modeled as rigid bodies having moments of inertia Je, Jm, Jl, respectively. The rigid bodies are drivingly coupled by the engine output shaft Eo, the input shaft I, the intermediate shaft M, and the output shaft. Thus, a two-inertia system is formed by the rotating electrical machine MG and the load LD when the engine disconnect clutch CL is in the non-direct-coupling engagement state, and a three-inertia system is formed by the engine E, the rotating electrical machine MG, and the load LD when the engine disconnect clutch CL is in the direct-coupling engagement state.

In this example, “Te” represents output torque that is output from the engine E, “ωe” represents the rotational speed (the angular velocity) of the engine E, and “Tf' represents slip torque that is transferred from the engine disconnect clutch CL to the side of the rotating electrical machine MG in the slipping engagement state. Moreover, “Tm” represents output torque that is output from the rotating electrical machine MG, “ωm” represents the rotational speed (the angular velocity) of the rotating electrical machine MG, and “Tcr” represents torsional reaction torque of the output shaft that is transferred to the rotating electrical machine MG via the speed change mechanism TM. “ωo” represents the rotational speed (the angular velocity) at the end of the output shaft located on the side of the speed change mechanism TM.

On the other hand, “Tc” represents torsional torque of the output shaft that is transferred to the load LD, “Td” represents disturbance torque due to slope resistance, air resistance, tire friction resistance, etc., which is transferred to the load LD, and “ωl” represents the rotational speed (the angular velocity) at the end of the output shaft located on the side of the load, which is the rotational speed (the angular velocity) of the load LD. In the speed change mechanism TM, the rotational speed obtained by dividing the rotational speed corn of the rotating electrical machine MG by the speed ratio Kr is the rotational speed coo of the output shaft at the end on the side of the speed change mechanism TM, and the torque obtained by dividing by the speed ratio Kr the torsional torque Tc of the output shaft that is transferred to the load LD is the torsional reaction torque Tcr of the output shaft that is transferred to the rotating electric& machine MG.

“Kc” represents a torsion spring constant of the output shaft, and “Cc” represents a viscous friction coefficient of the output shaft.

### 3-4-3. Two-Inertia Model

In the present embodiment, the engine output shaft Eo, the input shaft I, and the intermediate shaft M have a greater spring constant than the output shaft, and has a smaller amount of torsion than the output shaft. Thus, these shafts are simplified as the rigid bodies to facilitate analysis and design. Accordingly, as shown in FIG. 3C, when the engine disconnect clutch CL is in the direct-coupling engagement state, the engine E and the rotating electrical machine MG are treated as a single rigid body to simplify the inertia system from the three-inertia system to the two-inertia system.

As shown in FIGS. 3B and 3C, the moment of inertia on the side of the rotating electrical machine MG is switched between Jm and Jm+Je in accordance with whether the engine disconnect clutch CL is in the non-direct-coupling engagement state or in the direct-coupling engagement state. Thus, as described later, a resonant frequency ωa as a natural frequency of the shaft torsional vibration system changes significantly in accordance with the engagement state of the engine disconnect clutch CL. Moreover, since transfer of the rotational speed and the torque between the side of the rotating electrical machine MG and the side of the load LD also changes according to a change in speed ratio Kr, the resonant frequency ωa, etc. varies significantly in each of the non-direct-coupling engagement state and the direct-coupling engagement state. Thus, as described later, the damping controller is varied between the non-direct-coupling engagement state and the direct-coupling engagement state to adapt to a change in characteristics of the shaft torsional vibration system.

As shown in FIG. 3B, in the non-direct-coupling state in which there is slipping in the engine disconnect clutch CL, the slip torque Tf is input from the engine disconnect clutch CL to the rotating electrical machine MG by kinetic friction. As shown in FIG. 3C, in the case where the engine disconnect clutch CL is in the direct coupling engagement state, no slip torque Tf is input to the side of the rotating electrical machine MG, and the engine output torque Te is input instead. Thus, the torque that acts on the side of the rotating electrical machine MG is switched between the slip torque Tf and the output torque Te of the engine E at the moment the engagement state is switched between the non-direct-coupling engagement state and the direct-coupling engagement state. Thus, if the slip torque Tf is different in magnitude from the output torque Te of the engine E, a stepwise change in torque is input to the shaft torsional vibration system. Such a stepwise change in torque serves as a disturbance to the shaft torsional vibration system, thereby causing shaft torsional vibration. Thus, as described later, when the engagement state changes, switching to the damping controller adapted to the engagement state is made, whereby shaft torsional vibration caused by the change in engagement state can be quickly damped.

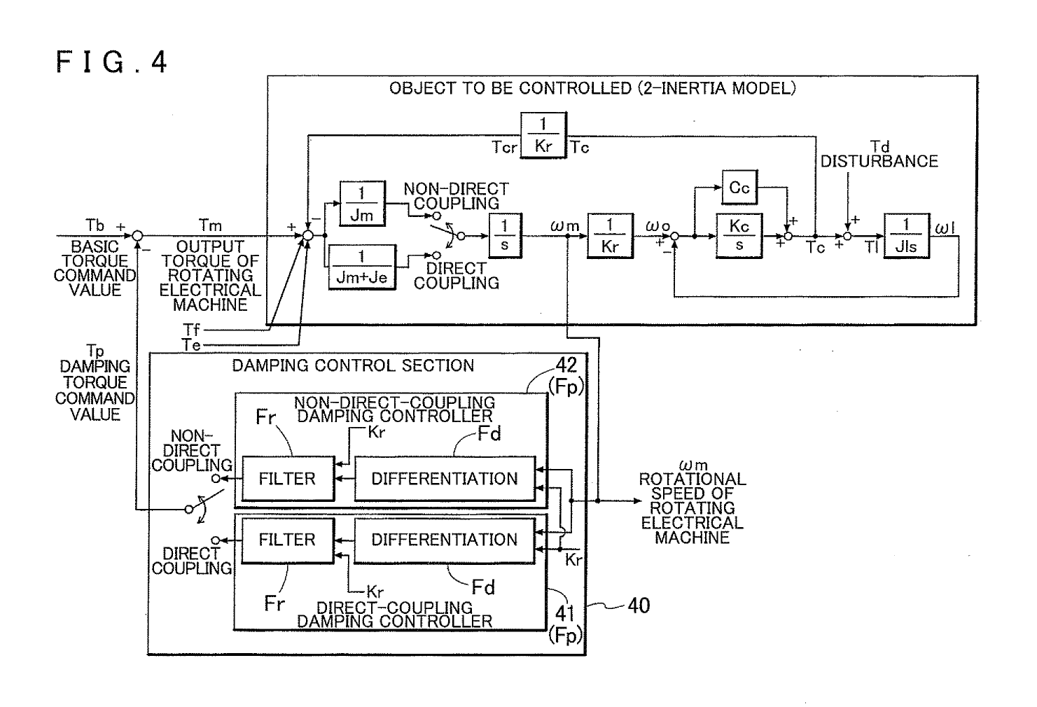

FIG. 4 is a block line diagram of the two-inertia model in FIGS. 3B and 3C, where “s” represents a Laplacian operator.

As shown in this drawing, the torque obtained by subtracting the torsional reaction torque Tcr of the output shaft from the output torque Tm of the rotating electrical machine MG and adding the slip torque Tf or the engine output torque Te to the resultant value is the torque that acts on the side of the rotating electrical machine MG. When the engine disconnect clutch CL is in the non-direct-coupling engagement state, the moment of inertia Jd on the side of the rotating electrical machine MG is equal to only the moment of inertia Jm of the rotating electrical machine MG. When the engine disconnect clutch CL is in the direct-coupling engagement state, the moment of inertia Jd on the side of the rotating electrical machine MG is equal to the sum (Jm+Je) of the moment of inertia Jm of the rotating electrical machine MG and the moment of inertia Je of the engine E. The moment of inertia is switched in this manner. The value obtained by dividing the torque acting on the side of the rotating electrical machine MG by the moment of inertia Jd is rotation acceleration (angular acceleration) of the rotating electrical machine MG. The value obtained by integrating (1/s) the rotation acceleration of the rotating electrical machine MG is the rotational speed (the angular speed) ωm of the rotating electrical machine MG.

The value obtained by dividing the rotational speed ωm of the rotating electrical machine MG by the speed ratio Kr is the rotational speed ωo at the end of the output shaft located on the side of the speed change mechanism TM. The value obtained by subtracting the rotational speed ωl at the end of the output shaft located on the side of the load LD from the rotational speed ωo at the end of the output shaft located on the side of the speed change mechanism TM is the differential rotational speed between these ends. The value obtained by multiplying this differential rotational speed by the viscous friction coefficient Cc of the output shaft is attenuation torque, and the value obtained by multiplying by the torsion spring constant Kc a torsion angle having a value obtained by integrating (1/s) the differential rotational speed is elastic torque. The sum of the attenuation torque and the elastic torque is the torsional torque Tc of the output shaft. The sum of the torsional torque Tc and the disturbance torque Td is the torque Tl that acts on the load LD. The value obtained by dividing the torque Tl acting on the load by the moment of inertia Jl of the load LD and integrating (1/s) the resultant value is the rotational speed (the angular velocity) ωl of the wheels as the load LD.

On the other hand, in the case where the friction engagement element that drivingly couples the side of the rotating electrical machine MG to the side of the load LD, such as during shifting of the speed change mechanism TM, is in the non-direct-coupling engagement state, the relation between the rotational speed ωm of the rotating electrical machine MG and the rotational speed ωo at the end on the side of the speed change mechanism TM, or the relation between the torsional torque Te of the output shaft and the torsional reaction torque Tcr of the output shaft does not change in accordance with the speed ratio Kr, in inverse proportion to the speed ratio Kr. Thus, no vibrational component is transmitted between the two inertia systems, and no resonance is produced.

In this example, the output torque Tm of the rotating electrical machine MG serves as control input to the two-inertia model to be controlled, and the rotational speed ωm of the rotating electrical machine MG serves as a variable that can be observed for the damping control. As described in detail later, the damping control section 40 performs the damping control of outputting the damping torque command value Tp by feedback control based on the rotational speed ωm of the rotating electrical machine MG

### 3-4-4. Change in Resonant Frequency In Accordance With Engagement State and Speed Ratio

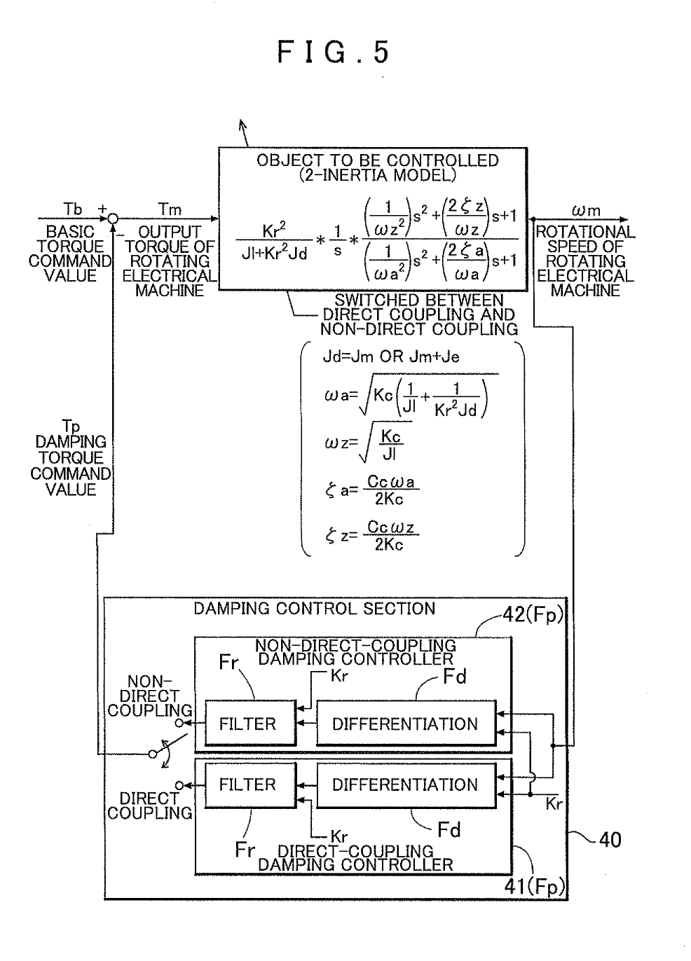

A transfer function P(s) from the output torque Tm of the rotating electrical machine MG to the rotational speed corn of the rotating electrical machine MG, which is to be controlled, is given by the following expression and FIG. 5, based on the block line diagram of the two-inertia model of FIG. 4.

$$P ( s ) = \frac{1}{\frac{1}{{Kr}^{2}} Jl + Jd} \frac{1}{s} \frac{( 1 \text{/} ω {z}^{2} ) {s}^{2} + 2 ( ζ z \text{/} ω z ) s + 1}{( 1 \text{/} ω {a}^{2} ) {s}^{2} + 2 ( ζ a \text{/} ω a ) s + 1} \qquad ( 1 )$$

In the above expression, “ωa” represents a resonant frequency, “ζa.” represents a attenuation factor at a resonant point, “ωz” represents an antiresonant frequency, and “ζz” represents an attenuation factor at an antiresonant point, and “ωa,” “ζa,” “ωz,” and “ζz” are given by the following expressions by using the torsion spring constant Kc and the viscous friction coefficient Cc of the output shaft, the moment of inertia Jl of the load (the vehicle), the moment of inertia Jd on the side of the rotating electrical machine MG, and the speed ratio Kr.

The moment of inertia Jd on the side of the rotating electrical machine MG is switched as described above between the non-direct-coupling engagement state and the direct-coupling engagement state. The speed ratio Kr is switched in accordance with the shift speed that is established in the speed change mechanism TM. Thus, as can be seen from the following expressions, the resonant frequency ωa is switched in accordance with the non-direct-coupling engagement state or the direct-coupling engagement state, and the speed ratio Kr.

$$ω a = \sqrt{Kc ( \frac{1}{Jl} + \frac{1}{{Kr}^{2} Jd} )} = \sqrt{Kc ( \frac{\frac{1}{{Kr}^{2}} Jl + Jd}{JlJd} )} \\ ζ a = \frac{Cc ω a}{2 Kc} \\ ω z = \sqrt{\frac{Kc}{Jl}} \\ ζ z = \frac{Cc ω z}{2 Kc} \qquad ( 2 )$$

(a) Non-direct-coupling engagement state

Jd=Jm

(b) Direct-coupling engagement state

Jd=Jm+Jl

Expression (1) shows that the rotational speed ωm of the rotating electrical machine MG is the rotational speed obtained by dividing the output torque Tm of the rotating electrical machine MG by the moment of inertia (Jl/Kr²+Jd) of the overall shaft torsional vibration system to obtain rotation acceleration, integrating (1/s) this resultant rotation acceleration to obtain the rotational speed in a steady state, and adding the two-inertia vibrational component to this rotational speed in the steady state.

Expression (2) shows that the resonant frequency ωa of the two-inertia vibrational component decreases when the engagement state is switched to the direct-coupling engagement state, because the moment of inertia Jd on the side of the rotating electrical machine MG increases by an amount corresponding to the moment of inertia Je of the engine E. Expression (2) also shows that the resonant frequency ωa varies in accordance with the moment of inertia (Jl/Kr²+Jd) of the overall shaft torsional vibration system.

The above expression also shows the following. Since the attenuation factor ζa at the resonant point is proportional to the resonant frequency ωa, the attenuation factor ζa decreases when the engagement state is switched to the direct-coupling engagement state. On the other hand, only the moment of inertia Jl of the load LD (the vehicle) relates to the antiresonant frequency ωz, and the antiresonant frequency ωz does not change in accordance with the engagement state. Since the attenuation factor ζz at the antiresonant point is proportional to the antiresonant frequency ωz, the attenuation factor ζz does not change even when the engagement state is switched to the direct-coupling engagement state. Thus, it can be seen from Expressions (1) and (2) that the resonant frequency ωa decreases and the attenuation factor ζa at the resonant point also decreases when the engine disconnect clutch CL is switched from the non-direct-coupling engagement state to the direct-coupling engagement state.

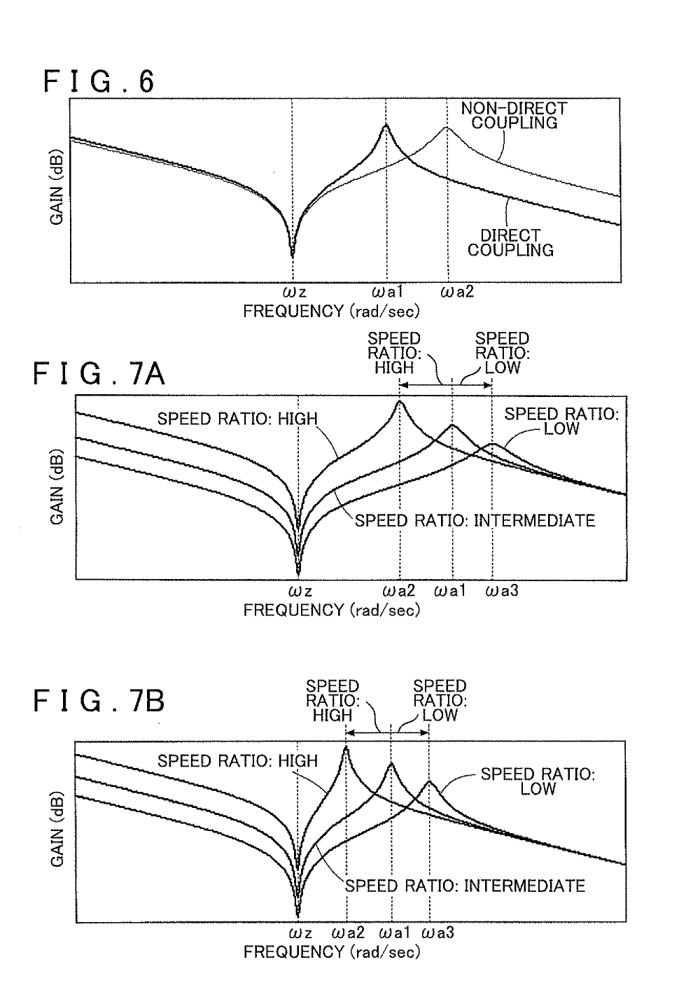

FIG. 6 shows an example of a Bode plot of the transfer function P(s) to be controlled. This Bode plot also shows that the resonant frequency ωa significantly decreases but the antiresonant frequency ωz does not change when the engagement state is switched from the non-direct-coupling engagement state to the direct-coupling engagement state.

Thus, the damping controller needs to be designed for each engagement state so as to be able to adapt to the resonant frequency ωa that changes between the direct-coupling engagement state and the non-direct-coupling engagement state.

Expression (2) shows that the resonant frequency ωa decreases as the speed ratio Kr increases. In the resonant frequency ωa of Expression (2), the moment of inertia Jd on the side of the rotating electrical machine MG is multiplied by the square of the speed ratio Kr, and a change in speed ratio Kr occurs together with a change in moment of inertia Jd in accordance with the engagement state, whereby the amount of change in resonant frequency ωa increases. Moreover, since the change in speed ratio Kr occurs together with the change in moment of inertia Jd in accordance with the engagement state, the tendency of the change in resonant frequency ωa due to the change in speed ratio Kr in the direct-coupling engagement state is different from the tendency of the change in resonant frequency ωa due to the change in speed ratio Kr in the non-direct-coupling engagement state. FIGS. 7A and 7B show examples of a Bode plot in the case where the speed ratio Kr is changed. This Bode plot also shows that the resonant frequency ωa decreases with an increase in speed ratio Kr, and the tendency of the change in resonant frequency ωa with the change in speed ratio Kr varies in accordance with the engagement state.

Thus, the damping controller needs to be designed so as to be able to adapt to the change in resonant frequency ωa due to the change in speed ratio Kr. Moreover, the damping controller needs to be designed for each engagement state so as to be able to adapt to the tendency of the change in resonant frequency ωa, which varies between the direct-coupling engagement state and the non-direct-coupling engagement state.

### 3-4-5. Switching of Damping Controller

In the present embodiment, in order to adapt to the change in resonant frequency ωa in accordance with the engagement state of the engine disconnect clutch CL and the speed ratio Kr, the damping control section 40 performs the damping control by the direct-coupling damping controller 41 in the case where the engine disconnect clutch CL is in the direct-coupling engagement state, and performs the damping control by the non-direct-coupling damping controller 42 different from the direct-coupling damping controller 41 in the case where the engine disconnect clutch CL is in the non-direct-coupling engagement state, as shown in FIG. 2. Thus, the damping control section 40 is configured so as to switch the damping controller in accordance with the engagement state to perform the damping control.

In this example, the direct-coupling damping controller 41 is set in accordance with the natural frequency, namely the resonant frequency ωa and the antiresonant frequency ωz, of the power transmission system from the engine E to the wheels E. The non-direct-coupling damping controller 42 is set in accordance with the natural frequency, namely the resonant frequency ωa and the antiresonant frequency ωz, of the power transmission system from the rotating electrical machine MG to the wheels E.

The damping control section 40 is configured so as to change the respective control constants of the direct-coupling damping controller 41 and the non-direct-coupling damping controller 42 in accordance with the speed ratio Kr of the speed change mechanism TM. That is, the control constants of each damping controller 41, 42 is set in accordance with the resonant frequency ωa that changes in accordance with the speed ratio Kr.

In the case where the friction engagement element that drivingly couples the side of the rotating electrical machine MG to the side of the wheels W is in the non-direct-coupling engagement state, such as during shifting of the speed change mechanism TM, no elastic (torsional) vibration of the power transmission mechanism 2 is produced, and thus, the damping control section 40 switches the controller to a shifting controller 43 to prohibit the damping control. Specifically, the damping torque command value Tp is set to zero.

In the present embodiment, the damping control section 40 includes a controller switching unit 44, and is configured to switch the controller to the direct-coupling damping controller 41, the non-direct-coupling damping controller 42, or the shifting controller 43 in accordance with the engagement state of the engine disconnect clutch CL and the shifting state of the speed change mechanism TM.

The controller switching unit 44 includes a direct-coupling determining section 45 and a shifting determining section 46. The direct-coupling determining section 45 is a function unit that determines the engagement state of the engine disconnect clutch CL. In the present embodiment, the direct-coupling determining section 45 determines that the engine disconnect clutch CL is in the direct-coupling engagement state, in the case where the rotational speed ωe of the engine E matches the rotational speed ωm of the rotating electrical machine MG in the state in which the engagement pressure is generated. In other cases, the direct-coupling determining section 45 determines that the engine disconnect clutch CL is in the non-direct-coupling engagement state. Note that the direct-coupling determining section 45 may determine that the engine disconnect clutch CL is in the direct-coupling engagement state, based on the engagement pressure of the engine disconnect clutch CL. That is, the direct-coupling determining section 45 may determine that the engine disconnect clutch CL is in the direct-coupling engagement state, in the case where the engagement pressure of the engine disconnect clutch CL is high enough to maintain the direct-coupling engagement state, and may, in other cases, determine that the engine disconnect clutch CL is in the non-direct-coupling engagement state.

The shifting determining section 46 is a function unit that determines if the speed change mechanism TM is performing a shift operation or not. That is, the shifting determining section 46 determines that the speed change mechanism TM is performing the shift operation in the case where each friction engagement element that establishes the shift speed of the speed change mechanism TM is in the non-direct-coupling engagement state. In other cases, the shifting determining section 46 determines that the speed change mechanism TM is not performing the shift operation. In a neutral state in which no shift speed is established in the speed change mechanism TM, the shift determining section 46 also determines that the speed change mechanism TM is performing the shift operation. In the present embodiment, the shifting determining section 46 determines that the engagement state is the direct-coupling engagement state, in the case where the rotational speed obtained by multiplying the rotational speed ωo of the output shaft O by the speed ratio Kr matches the rotational speed ωm of the rotating electrical machine MG. In other cases, the shifting determining section 46 determines that the engagement state is the non-direct-coupling engagement state. Note that in the case where friction engagement elements that engage and disengage driving coupling (that is, release and maintain coupling) between the rotating electrical machine MG and the wheels W, or friction engagement elements that bring a torque converter and input/output members of the torque converter into the direct-coupling engagement state is provided in addition to the speed change mechanism TM, the shifting determining section 46 may be configured to determine that the speed change mechanism TM is performing the shift operation and to prohibit the damping control, even in the case where these friction engagement elements are in the non-direct-coupling engagement state.

### 3-4-6. Setting of Damping Controller

An example of the damping controller Fp designed to adapt to the change in resonant frequency ωa in accordance with the engagement state of the engine disconnect clutch CL and the speed ratio Kr will be described below with reference to FIGS. 4 and 5.

The damping controller Fp is configured to output the damping torque command value Tp by the feedback control that performs at least differentiation Fd and filtering Fr. Control constants of the differentiation Fd and the filtering Fr of the direct-coupling damping controller 41 are set to different values from those of the differentiation Fd and the filtering Fr of the non-direct-coupling damping controller 42.

In the present embodiment, the damping controller Fp is configured by the differentiation Fd and the filtering Fr, and can be represented by a transfer function given by the following expression.

Fp(s)=Ff(s)Fd(s) (3)

### 3-4-6-1. Differentiation

A differential gain of the differentiation Fd is changed in accordance with a change in resonant frequency ωa. In the present embodiment, the differential gain of the differentiation Fd is set in accordance with the moment of inertia Jd on the side of the rotating electrical machine MG and the speed ratio Kr which correlate with the resonant frequency ωa based on Expression (2).

FIG. 4 shows that, in order to damp torsional vibration, the rotating electrical machine MG may be configured to output such damping torque that cancels the torsional reaction torque Tcr that is transferred to the rotating electrical machine MG That is, the block line diagram to be controlled in FIG. 4 shows that the rotational speed ωm of the rotating electrical machine MG is a value obtained by subtracting the torsional reaction torque Tcr from the output torque Tm of the rotating electrical machine MG, dividing the resultant torque by the moment of inertia Jd on the side of the rotating electrical machine MG, and integrating (1/s) the resultant value. It can be seen that information of the torsional reaction torque Tcr can be obtained by performing processing in a reverse direction to the direction of this processing, namely by differentiating (s) the rotational speed ωm of the rotating electrical machine MG and multiplying the resultant value by the moment of inertia Jd on the side of the rotating electrical machine MG. Thus, as shown in the block line diagram of the damping control section 40 of FIG. 4, the damping controller Fp calculates the damping torque command value Tp based on the value obtained by differentiating (s) the rotational speed ωm of the rotating electrical machine MG and multiplying the resultant value by the differential gain. Thus, the damping controller Fp can calculate such a torque command value that cancels the torsional reaction torque Tcr.

The block line diagram to be controlled in FIG. 4 shows that the moment of inertia Jd on the side of the rotating electrical machine MG by which the torsional reaction force Tcr is divided is switched to Jm or Jm+Je in accordance with whether the engagement state is the non-direct-coupling engagement state or the direct-coupling engagement state. This shows that in order to prevent the canceling function of the torsional reaction torque Tcr from changing by the change in engagement state, the differential gain by which the differentiated value is multiplied in the damping controller Fp needs to be changed in accordance with the engagement state.

The present embodiment is configured so that the differential gain is changed in accordance with the moment of inertia Jd on the side of the rotating electrical machine MG, and is configured so that the canceling function of the torsional reaction torque Tcr does not change by the change in engagement state.

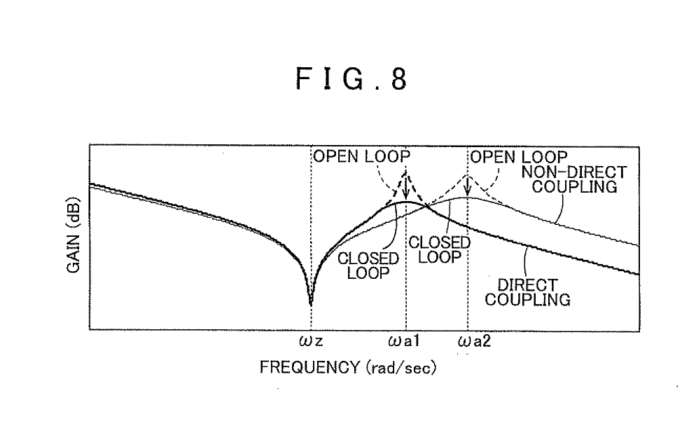

FIG. 8 shows frequency characteristics of a closed loop in the case where the differentiation Fd is used as the damping controller Fp. As shown in this drawing, in the resonant frequency ωm of the transfer function P(s) to be controlled, a gain peak of the resonant point is reduced by performing the damping control (in the closed loop). This shows that the use of the damping controller Fp using the differentiation Fd reduces the amplitude of torsional vibration.

In the present embodiment, each of the direct-coupling damping controller 41 and the non-direct-coupling damping controller 42 includes the resonant frequency ωa that changes in accordance with the engagement state, and the differentiation Fd that is set in accordance with the peak value of the resonant frequency ωa. Thus, the damping control section 40 can adapt to the change in resonant frequency ωa of the shaft torsional vibration system by merely switching the damping controller between the direct-coupling damping controller 41 and the non-direct-coupling controller 42 in accordance with the engagement state of the engine disconnect clutch CL.

In the present embodiment, the direct-coupling damping controller 41 includes, for each shift speed of the speed change mechanism TM, the resonant frequency ωa and the differential gain that is set in accordance with the peak value of the resonant frequency ωa. The non-direct-coupling damping controller 42 also includes, for each shift speed of the speed change mechanism TM, the resonant frequency ωa and the differential gain that is set in accordance with the peak value of the resonant frequency ωm. The damping control section 40 changes the differential gain of the direct-coupling damping controller 41 or the non-direct-coupling damping controller 42 in accordance with the shift speed (the speed ratio Kr) of the speed change mechanism TM. Thus, the damping control section 40 can adapt to the resonant frequency ωa of the shaft torsional vibration system that changes in accordance with the speed ratio Kr of the speed change mechanism TM.

In the present embodiment, the direct-coupling damping controller 41 and the non-direct-coupling damping controller 42 are formed by the differentiation, and are configured to calculate a momentary amount of change with no past control values being accumulated as in the integration. Thus, the damping torque command value Tp does not significantly change even when the controller is switched between these controllers. Thus, in the case where the engagement state of the engine disconnect clutch CL is changed, the damping controller can be rapidly switched between the damping controllers 41, 42, and the damping control adapted to the change in resonance frequency ωa can be continuously performed. Moreover, since the damping controllers 41, 42 are formed by the differentiation, the damping torque command value adapted to the change in resonance frequency ωa can be output immediately after the damping controller is switched between the damping controllers 41, 42. Thus, the damping can be quickly performed on a stepwise torque disturbance that is input when the engagement state is changed.

Note that in the present embodiment, in the case where the engine disconnect clutch CL is switched to the direct-coupling engagement state, the inertia system is simplified from the three-inertia system to the two-inertia system by using as a rigid body the shaft that drivingly couples the engine E to the rotating electrical machine TM. However, in the case where the shaft between the engine E and the rotating electrical machine MG has a small spring constant, and three-inertia torsional vibration is generated, such as in the case where the engine output shaft Eo of the engine E is provided with a damper, only the direct-coupling damping controller 41 can be changed so as to adapt to the three-inertia torsional vibration. For example, the damping controller Fp may be set from the differentiation to higher-order phase-advance calculation (e.g., as²+bs+1) than the differentiation. Thus, since the direct-coupling damping controller 41 and the non-direct-coupling damping controller 42 are individually set and switched, the damping controller Fp that is adapted to the model of the shaft torsional vibration system that changes in accordance with the engagement state can be individually set.

### 3-4-6-2. Filtering

A filter frequency band, which is a frequency band to be cut off in the filtering Fr, is set in accordance with the resonant frequency ωa that changes in accordance with the engagement state or the speed ratio Kr.

In the present embodiment, the filtering Fr is set to low-pass filtering, and in this example, is set to first-order lag filtering.

$$Ff ( s ) = \frac{1}{1 \text{/} τ s + 1} \qquad ( 4 )$$

A cutoff frequency τ, which is a filter frequency band in the low pass filtering, is set based on the resonant frequency ωa.

In the present embodiment, each of the direct-coupling damping controller 41 and the non-direct-coupling damping controller 42 has a filter frequency band that changes in accordance with the engagement state. Thus, the damping control section 40 can perform the filtering corresponding to the change in resonant frequency ωa of the shaft torsional vibration system, by merely switching the damping controller between the direct-coupling damping controller 41 and the non-direct-coupling damping controller 42 in accordance with the engagement state of the engine disconnect clutch CL.

In the present embodiment, the direct-coupling damping controller 41 includes, for each shift speed of the speed change mechanism TM, a filter frequency band that is set based on the speed ratio Kr of each shift speed of the speed change mechanism TM. The non-direct-coupling damping controller 42 includes, for each shift speed of the speed change mechanism TM, a filter frequency band that is set based on the speed ratio Kr of each shift speed of the speed change mechanism TM. The damping control section 40 changes the filter frequency band of the direct-coupling damping controller 41 or the non-direct-coupling damping controller 42 in accordance with the shift speed (the speed ratio Kr) of the speed change mechanism TM. Thus, the damping control section 40 can perform the filtering corresponding to the resonant frequency ωa of the shaft torsional vibration system that changes in accordance with the speed ratio Kr of the speed change mechanism TM.

Note that in FIGS. 4 and 5, the damping controller Fp is shown to perform the filtering Fr after the differentiation Fd. However, the damping controller Fp may be configured to perform the differentiation Fd after the filtering Fr.

### 3-4-7. Behavior of Damping Control

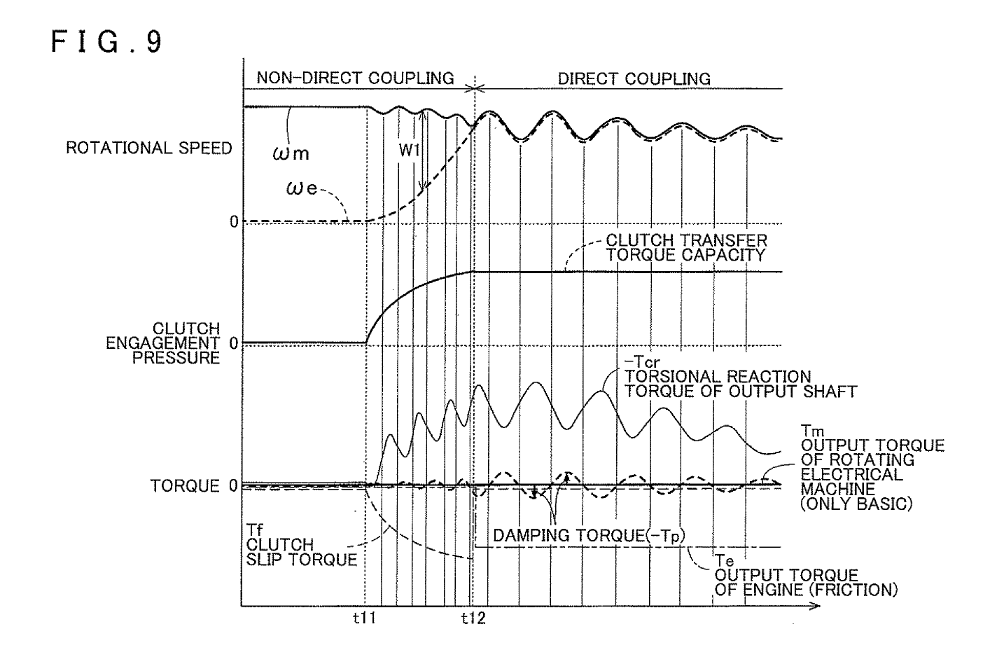

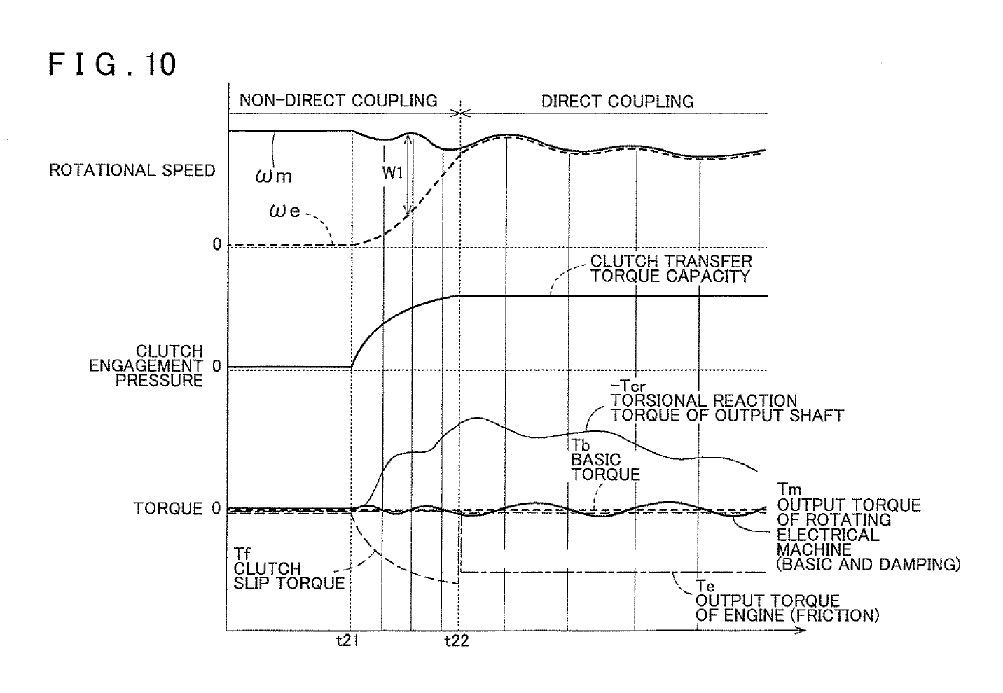

The behavior of the damping control by the damping control section 40 will be described based on the timing chart shown in examples of FIGS. 9 and 10. FIGS. 9 and 10 show the examples in which the engine disconnect clutch CL is switched from the non-direct-coupling engagement state to the direct-coupling engagement state in the engine start mode. FIG. 9 shows an example in which no damping control is performed, and FIG. 10 shows an example in which the damping control is performed.

### 3-4-7-1. In the Case Where No Damping Control is Performed

First, the example of FIG. 9 will be described. In the state in which the engine E is stopped and the rotating electrical machine MG is rotating, the engagement pressure of the engine disconnect clutch CL starts being increased in order to start the engine E (time t11). The transfer torque capacity increases in proportion to the increase in engagement pressure of the engine disconnect clutch CL. As the transfer torque capacity increases from zero, negative slip torque Tf having the magnitude of the transfer torque capacity is transferred from the engine disconnect clutch CL to the side of the rotating electrical machine MG. Since the magnitude of the slip torque Tf rapidly increases with the increase in engagement pressure, this serves as a disturbance to the shaft torsional vibration system, and torsional vibration starts being generated. Since the engine disconnect clutch CL is in the non-direct-coupling engagement state at this time, the resonant frequency ωa is high, and resonant vibration having a relatively high frequency is generated.

On the other hand, positive torque having the magnitude of the transfer torque capacity is transferred from the engine disconnect clutch CL to the side of the engine E, and the rotational speed ωe of the engine E increases accordingly. When the rotational speed ωe of the engine E increases to the rotational speed ωm of the rotating electrical machine MG, and both rotational speeds have the same value (time t12), the engine disconnect clutch CL changes from the non-direct-coupling engagement state to the direct-coupling engagement state. When the engine disconnect clutch CL changes to the direct-coupling engagement state, the slip torque Tf becomes zero, and the output torque Te of the engine E starts being transferred to the rotating electrical machine MG. In this example, combustion of the engine E is stopped, and the engine E outputs friction torque that is negative torque. Thus, the negative friction torque is transferred to the rotating electrical machine MG. Accordingly, at the moment the engagement state is switched between the non-direct-coupling engagement state and the direct-coupling engagement state, the torque that is transferred to the side of the rotating electrical machine MG is switched between the slip torque Tf and the output torque Te of the engine E. Therefore, in the case where the slip torque Tf is different in magnitude from the output torque Te of the engine E, a stepwise change in torque is input to the shaft torsional vibration system. This stepwise change in torque serves as a disturbance to the shaft torsional vibration system, and shaft torsional vibration is also generated by this disturbance.

When the engine disconnect clutch CL changes to the direct-coupling engagement state, the moment of inertia Jd on the side of the rotating electrical machine MG increases from Jm to Jm+Je. Thus, the resonant frequency ωa, decreases, and the vibration period of the torsional vibration increases as shown in FIG. 9.

When the torsional vibration of the output shaft is generated, the torsional reaction torque Tcr starts being transferred from the output shaft O to the rotating electrical machine MG via the speed change mechanism TM. In the example of FIG. 9, no damping control is performed, and the output torque of the rotating electrical machine MG is constant. Thus, the waveform obtained by dividing the torsional reaction torque Tcr by the moment of inertia Jd on the side of the rotating electrical machine MG and integrating the resultant value correlates with the waveform of the rotational speed ωm of the rotating electrical machine MG. Thus, the waveform obtained by differentiating the rotational speed ωm of the rotating electrical machine MG correlates with the waveform of the torsional reaction torque Tcr. FIG. 9 also shows, for reference, the damping torque command value Tp that is output from the damping control section 40, although not reflected on the output torque Tm of the rotating electrical machine MG. In the present embodiment, the damping control section 40 calculates the damping torque command value Tp by differentiating the rotational speed ωm of the rotating electrical machine MG. Thus, the damping torque command value Tp is torque in such a direction that cancels the torsional reaction torque Tcr.

The damping control section 40 switches the damping controller from the non-direct-coupling damping controller 42 to the direct-coupling damping controller 41 when the engagement state changes from the non-direct-coupling engagement state to the direct-coupling engagement state (time t12). Thus, the differential gain is increased so as to be able to adapt to the change in resonant frequency ωm. Thus, the magnitude of the damping torque command value at time t12 and later increases. This shows that the torsional vibration can be continuously suppressed by switching the damping controller between the damping controllers 41, 42, even immediately after the engagement state is changed. For the stepwise change in torque between the slip torque Tf and the output torque Te of the engine E, which is caused when the engagement state is changed, switching to the damping controller adapted to the engagement state is made, whereby the shaft torsional vibration that is generated by the change in engagement state can be quickly damped.

### 3-4-7-2. In the Case Where Damping Control is Performed

FIG. 10 shows an example in which operating conditions are the same as those of FIG. 9, and the damping control is performed. Since the damping control is performed, the amplitude of the torsional vibration of the rotational speed ωm of the rotating electrical machine MG is reduced.

When the engine disconnect clutch CL is changed from the non-direct-coupling engagement state to the direct-coupling engagement state (time t22), the damping controller is switched from the non-direct-coupling damping controller 42 to the direct-coupling damping controller 41, and the differential gain is increased. In the example of FIG. 10, the magnitude of the damping torque command value Tp at time t22 and later increases, although it is not clearly shown in the drawing because the damping is performed. Thus, even when the engagement state is changed, the damping controller is switched between the damping controllers 41, 42, and the torsional vibration is continuously suppressed.

### 4. Other Embodiments

Lastly, other embodiments of the present invention will be described. Note that the configuration of each embodiment described below is not limited to applications in which the configuration of each embodiment is used solely, and unless inconsistent, may be used in combination with the configuration of any of the other embodiments.

(1) The above embodiment is described with respect to an example in which the speed change mechanism TM is a stepped automatic transmission device. However, the present invention is not limited to this. That is, it is also one of preferred embodiments of the present invention that the speed change mechanism TM be a transmission device other than the stepped automatic transmission device, such as a continuously variable automatic transmission device in which the speed ratio can be continuously changed. In this case as well, the damping control section 40 is configured to change the control constants of the direct-coupling damping controller 41 and the non-direct-coupling damping controller 42 in accordance with the speed ratio of the continuously variable automatic transmission device. In this case, the damping control may be executed even during the shifting operation of the speed ratio, or the control constants of the direct-coupling damping controller 41 and the non-direct-coupling damping controller 42 may be continuously changed in accordance with the speed ratio, based on an operational expression such as Expression (2), or based on a map in which the relation between the speed ratio and each control constant is set.

(2) The above embodiment is described with respect to an example in which the engine disconnect clutch CL is a hydraulic friction engagement element. However, the present invention is not limited to this. That is, it is also one of preferred embodiments of the present invention that the engine disconnect clutch CL be an engagement device other than the hydraulic friction engagement element, such as an electromagnetic clutch or a dog clutch. In this case, the damping control section 40 may be configured to determine that the engagement state is the direct-coupling engagement state in the case where the engine E rotates together with the rotating electrical machine MG, and to determine that the engagement state is the non-direct-coupling engagement state in other cases.

(3) The above embodiment is described with respect to an example in which the hybrid vehicle is provided with the control devices 31 to 34, and the rotating electrical machine control device 32 includes the damping control section 40. However, the present invention is not limited to this. That is, the rotating electrical machine control device 32 may be provided as a control device that is integrated in any combination with any of the plurality of control devices 31, 33, 34, and assignment of the function units included in the control devices 31 to 34 may be arbitrarily set.

(4) The above embodiment is described with respect to an example in which the direct-coupling damping controller 41 and the non-direct-coupling damping controller 42 are formed by separate controllers. However, the present invention is not limited to this. That is, it is also one of preferred embodiments of the present invention that the direct-coupling damping controller 41 and the non-direct-coupling damping controller 42 be formed by an integral controller, and only the control constant be switched in accordance with the engagement state and the change in speed ratio Kr.

The present invention can be preferably used in control devices for controlling a rotating electrical machine that is selectively drivingly coupled to an internal combustion engine in accordance with an engagement state of an engagement device, and that is drivingly coupled to wheels via a power transmission mechanism.

What is claimed is:

1. A control device for controlling a rotating electrical machine that is selectively drivingly coupled to an internal combustion engine in accordance with an engagement state of an engagement device, and that is drivingly coupled to a wheel via a power transmission mechanism, wherein
the control device is capable of executing damping control of outputting a damping torque command that suppresses vibration of a rotational speed of the rotating electrical machine caused at least by elastic vibration of the power transmission mechanism, by using feedback control based on the rotational speed of the rotating electrical machine, and
the control device executes the damping control by a direct-coupling damping controller in a case where the engagement state of the engagement device is a direct-coupling engagement state in which there is no rotational speed difference between engagement members, and executes the damping control by a non-direct-coupling damping controller different from the direct-coupling damping controller in a case where the engagement state of the engagement device is a non-direct-coupling engagement state other than the direct-coupling engagement state.

2. The control device according to claim 1, wherein
the direct-coupling damping controller is set in accordance with a natural frequency of a power transmission system from the internal combustion engine to the wheel, and
the non-direct-coupling damping controller is set in accordance with the natural frequency of the power transmission system from the rotating electrical machine to the wheel.

3. The control device according to claim 1, wherein
in the damping control, the control device outputs the damping torque command by the feedback control that performs at least differentiation and filtering based on the rotational speed of the rotating electrical machine, and
a control constant of the differentiation and the filtering in the direct-coupling damping controller and a control constant of the differentiation and the filtering in the non-direct-coupling damping controller are set to be different from each other.

4. The control device according to claim 1, wherein
the power transmission mechanism includes a speed change mechanism whose speed ratio can be changed, and
the respective control constants of the direct-coupling damping controller and the non-direct-coupling damping controller are changed in accordance with the speed ratio of the speed change mechanism.

5. The control device according to claim 1, wherein
the power transmission mechanism includes a speed change mechanism whose speed ratio can be changed, and
execution of the damping control is prohibited during a shifting operation of the speed ratio by the speed change mechanism.
